(19) United States
(12) Patent Application Publication
(10) Pub. No.: US 2006/0005012 A1
(43) Pub. Date: Jan. 5, 2006

(54) Efficient security parameter index selection in virtual private networks

(75) Inventors: Yashodhan Deshpande, San Jose, CA (US); Ravi Voleti, Fremont, CA (US); Manohar Mahavadi, Fremont, CA (US)

Correspondence Address: David B. Ritchie;THELEN REID & PRIEST LLP, P.O. BOX 640640, SAN JOSE, CA, 95164-0640, US

(73) Assignee: IPolicy Networks, Inc., a Delaware corporation

(21) Appl. No.: 10/873,761

(22) Filed: Jun. 21, 2004

(51) Int. Cl. H04L 9/00

(52) U.S. Cl. 713/160

(57) ABSTRACT

A solution is provided for manual configuration of SPIs without requiring time-consuming checks for overlapping allocations between multiple customers by utilizing a unique decryption process. In this process, the data available in the incoming encrypted packets is considered to uniquely identify the different traffic streams even with overlapping SPIs. The destination address, SPI, and source address parameters present in the outer header of received encrypted packets may be hashed to yield an index, which may be used for searching a security association database to uniquely identify the properties of the security association. Using this process, customer administrators can configure manual SPIs without concern for any overlap or duplication by other customer administrators.

### FIELD OF THE INVENTION

The present invention relates to the field of computer network security. More specifically, the present invention relates to the efficient selection of security parameter indexes between multiple customers in a multi-customer virtual private network environment.

### BACKGROUND OF THE INVENTION

A virtual private network (VPN) is a wide area network that connects private subscribers (such as employees of the same company in different locations) together using the public Internet as a transport medium, while ensuring that their traffic is not readable by the Internet at large. All of the data is encrypted to prevent others from reading it, and authentication measures ensure that only messages from authorized VPN users can be received.

Internet Protocol Security (Ipsec) is a standard for security on the Internet that is commonly used to implement VPNs. IPsec (and other VPN standards) utilizes security associations in creating VPNs. These security associations, also known as tunnels, are typically negotiated by the end nodes before traffic is secured.

A security association is established by either manually configuring or automatically negotiating IPsec parameters including security parameter indexes (SPIs) required for securing the traffic. An SPI is a number that indicates a particular set of unidirectional attributes used under a Security Association, such as transform(s) and session-key(s). This number is relative to the IP Destination, which is the SPI Owner, and is unique per Security Association. That is, the same value may be used by multiple customers or owners to concurrently indicate different Security Association parameters.

The automatic negotiation of security associations offers flexibility with no administrator intervention other than configuring the policies and security properties, but involves the overhead of the Internet Security Association Key Management Protocol (ISAKMP) and the IPsec protocol, both of which are processor-intensive. Other drawbacks of automatic negotiation include the interruption to traffic due to keys expiring, and latencies introduced into the system by the automatic negotiations.

Manual configuration of the security parameters offers a simple method for establishing a security association. Using this method, an administrator can configure all of the properties of a secure tunnel between two end points and assign the required SPIs. Advantages of this method include that it is simple to configure, traffic is secured as soon as the configuration is applied since there is no time lost due to negotiation with the remote node, and there is no interruption to traffic due to re-keying of the security association on the expiration of a key. Manually configuring the security association may also be used in conjunction with automatic negotiation, with the administrator for manually checking or debugging the secured connection with the remote node before establishing multiple other tunnels using automatic negotiation.

Despite the advantages of manual configuration of security associations, in a multi-customer environment secured by a common VPN gateway the manual SPIs cannot overlap for traffic between multiple customers. Therefore, if two customers whose traffic is secured by the gateway use the same SPI, the encrypted packets received through the untrusted network cannot be uniquely decrypted. The administration of SPI allocation to avoid this type of overlapping requires multiple checks at multiple locations, and is not scalable since administrators of different customer networks require coordination.

What is needed is a solution that provides the advantage of manual configuration of SPIs without requiring time-consuming checks for overlapping allocations between multiple customers.

### BRIEF DESCRIPTION

A solution is provided for manual configuration of SPIs without requiring time-consuming checks for overlapping allocations between multiple customers by utilizing a unique decryption process. In this process, the data available in the incoming encrypted packets is considered to uniquely identify the different traffic streams even with overlapping SPIs. The destination address, SPI, and source address parameters present in the outer header of received encrypted packets may be hashed to yield an index, which may be used for searching a security association database to uniquely identify the properties of the security association. Using this process, customer administrators can configure manual SPIs without concern for any overlap or duplication by other customer administrators.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a flow diagram illustrating a method for determining a security association for a packet in accordance with an embodiment of the present invention.

FIG. 2 is a flow diagram illustrating a method for manually configuring an SPI for a security association in accordance with an embodiment of the present invention.

FIG. 3 is a diagram illustrating data structure relationships in accordance with an embodiment of the present invention.

FIG. 4 is a block diagram illustrating an apparatus for determining a security association for a packet in accordance with an embodiment of the present invention.

FIG. 5 is a block diagram illustrating an apparatus for manually configuring an SPI for a security association in accordance with an embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides for manual configuration of SPIs without requiring time-consuming checks for overlapping allocations between multiple customers by utilizing a unique decryption process. In this process, the data available in the incoming encrypted packets is considered to uniquely identify the different traffic streams even with overlapping SPIs. The destination IP address, SPI, and source IP address parameters present in the outer header of received encrypted packets may be hashed to yield an index, which may be used for searching a security association database to uniquely identify the properties of the security association. Using this process, customer administrators can configure manual SPIs without concern for any overlap or duplication by other customer administrators.

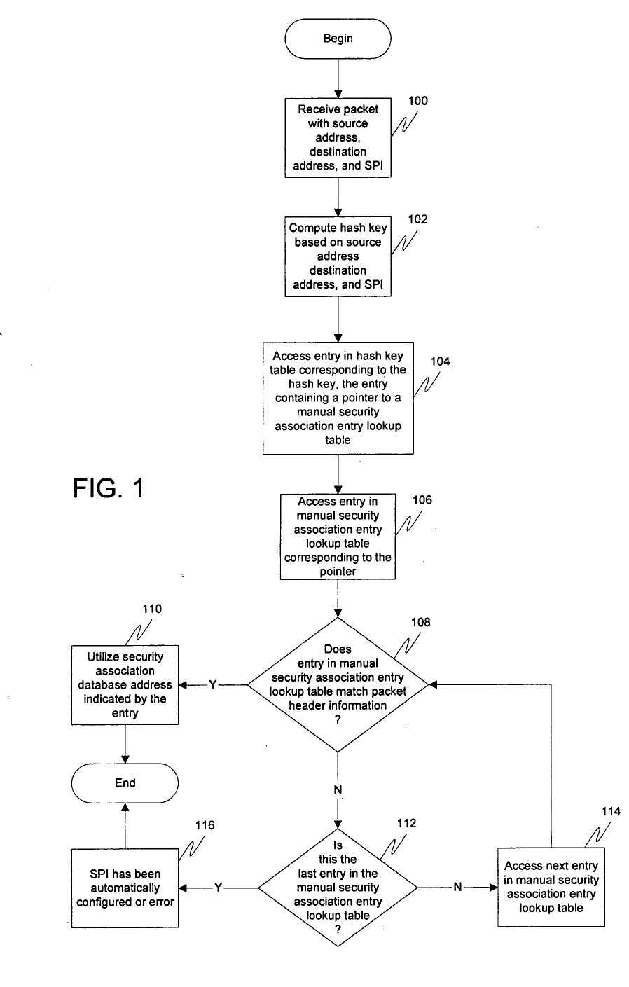

FIG. 1 is a flow diagram illustrating a method for determining a security association for a packet in accordance with an embodiment of the present invention. At 100, the packet may be received. This packet may include header information (such as destination address and source address), as well as an SPI. If the SPI was manually configured, then it may have been assigned by an administrator without any regard for whether it overlaps another SPI. At 102, a hash key may be computed based on the destination address, source address, and SPI from the packet. Computing the hash key may include performing an exclusive-OR operation on the destination address, SPI, and source address indicated by the packet. It should be noted that in one implementation, the source address, destination address, and SPI, have 32 bits, and the lower 16 bits of the fields may be exclusive OR-ed with the upper 16 bits of the fields and combined together to yield a hash index.

At 104, a hash key table may be accessed using the hash key. This hash key table may include, for each entry, a pointer to a manual security association entry lookup table corresponding to that particular hash index. As there is the possibility that there will be more than one security association sharing the same hash key, each manual security association entry lookup table may contain multiple entries. It should also be noted that the separation of the manual security association entry lookup tables is merely an implementation choice. One of ordinary skill in the art would recognize it is possible to have all the manual security association entry lookup tables combined into one big table, with pointers or other devices used to distinguish between the end of one and the beginning of another. Nevertheless, for purposes of this document, the term manual security association entry lookup table should be interpreted to allow either implementation.

At 106, an entry in the manual security association entry lookup table referenced by the pointer may be accessed. The manual security association entry lookup table entries may contain security association information such as source address, destination address, and SPI. At 108, these three parameters may be compared to the source address, destination address, and SPI indicated by the packet to determine if a match occurs. If there is a match, then a security association for the packet has been identified and a security association database address indicated by the entry may be utilized for decryption purposes at 110. If, on the other hand, the entry does not match, then at 112 it may be determined if this is the last entry in the manual security association entry lookup table. If not, then at 114 the next entry in the manual security association entry lookup table may be accessed, and the process may return to 108. If no match is found in the table, then at 116, the SPI has been automatically configured (not manually configured) or an error has occurred.

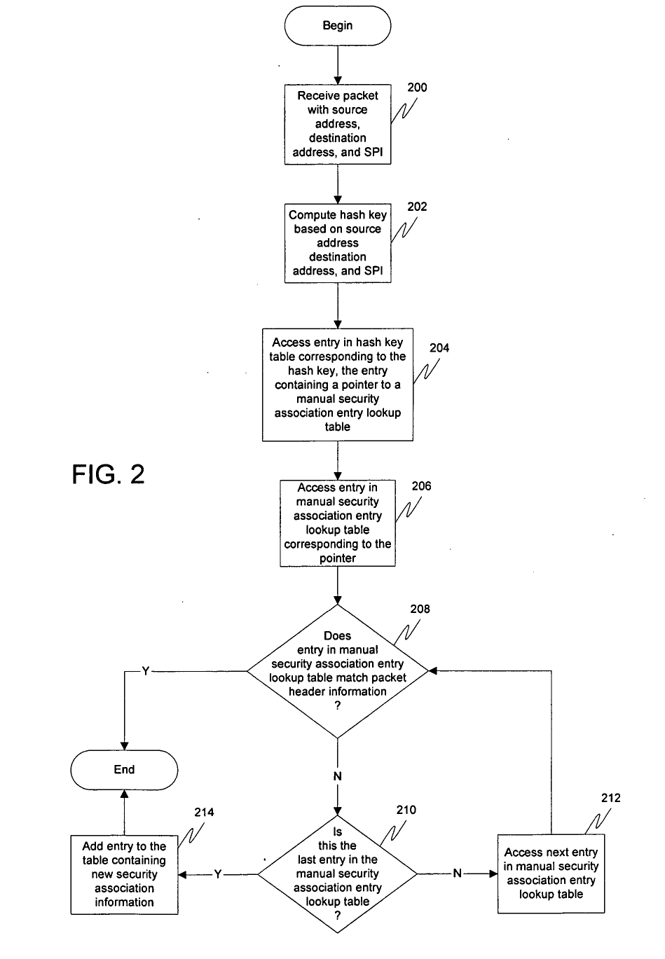

The present invention allows an administrator to more easily configure a manual SPI. As opposed to having to run a series of checks to determine if there is overlap, he may simply ignore the possibility of an overlap. FIG. 2 is a flow diagram illustrating a method for manually configuring an SPI for a security association in accordance with an embodiment of the present invention. At 200, an SPI assigned to the security association may be received from the administrator in a packet containing header information (such as destination address and source address). At 202, a hash key may be computed based on the destination address, source address, and SPI from the packet. This may be similar to 102 of FIG. 1.

At 204, a hash key table may be accessed using the hash key. At 206, the entry in the manual security association entry lookup table referenced by the pointer may be accessed. At 208, it may be determine if a match is found. This may be similar to 108 of FIG. 1. If a match is found, then a security association has already been set up matching the parameters, and there is no need to continue. If it doesn't match, however, then at 210 it may be determined if there are any more entries in the manual security association entry lookup table referenced by the pointer. If so, then the next entry in the table may be accessed at 212. If not, however, then the security association may be set up and an entry added to the table containing the security association information at 214.

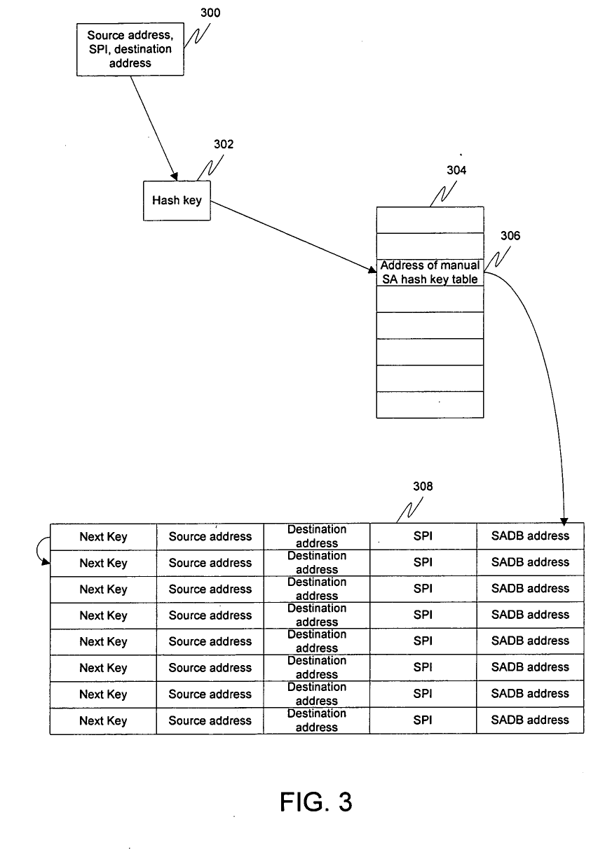

FIG. 3 is a diagram illustrating data structure relationships in accordance with an embodiment of the present invention. Here, the three parameters from the packet 300 may be used to compute the hash key 302, which is in turn used to access the hash key table 304 to find a corresponding entry 306 which contains an address of a manual security association hash table 308.

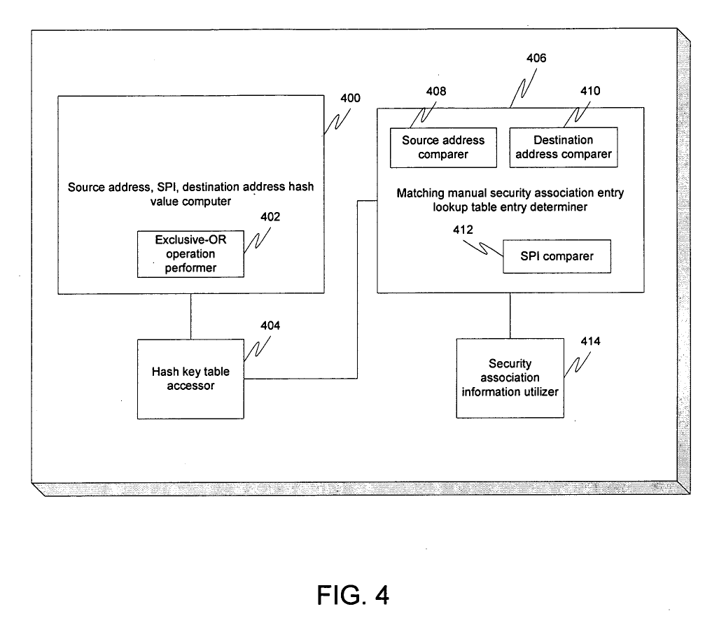

FIG. 4 is a block diagram illustrating an apparatus for determining a security association for a packet in accordance with an embodiment of the present invention. This packet may include header information (such as destination address and source address), as well as an SPI. If the SPI was manually configured, then it may have been assigned by an administrator without any regard for whether it overlaps another SPI. A source address, destination address, SPI hash key computer 400 may compute a hash key based on the destination address, source address, and SPI from the packet. Computing the hash key may include performing an exclusive-OR operation using an exclusive-OR operation performer 402 on the destination address, SPI, and source address indicated by the packet.

A hash key table accessor 404 coupled to the source address, destination address, SPI hash key computer 400 may access a hash key table using the hash key. This hash key table may include, for each entry, a pointer to a manual security association entry lookup table corresponding to that particular hash index. As there is the possibility that there will be more than one security association sharing the same hash key, each manual security association entry lookup table may contain multiple entries. It should also be noted that the separation of the manual security association entry lookup tables is merely an implementation choice. One of ordinary skill in the art would recognize it is possible to have all the manual security association entry lookup tables combined into one big table, with pointers or other devices used to distinguish between the end of one and the beginning of another. Nevertheless, for purposes of this document, the term manual security association entry lookup table should be interpreted to allow either implementation.

A matching manual security association entry lookup table entry determiner 406 coupled to the hash key table accessor 404 may access the manual security association entry lookup table referenced by the pointer and determine if an entry matches the packet. The manual security association entry lookup table entries may contain security association information such as source address, destination address, and SPI. The matching manual security association entry lookup table entry determiner 406 may contain a source address comparer 408, a destination address comparer 410, and an SPI comparer 412, which may compare these three parameters to the source address, destination address, and SPI indicated by the packet to determine if a match occurs. If there is a match, then a security association for the packet has been identified and a security association database address indicated by the entry may be utilized for decryption purposes using a security association information utilizer 414 coupled to the matching manual security association entry lookup table entry determiner 406.

If no match is found in the table, then the SPI has been automatically configured (not manually configured) or an error has occurred.

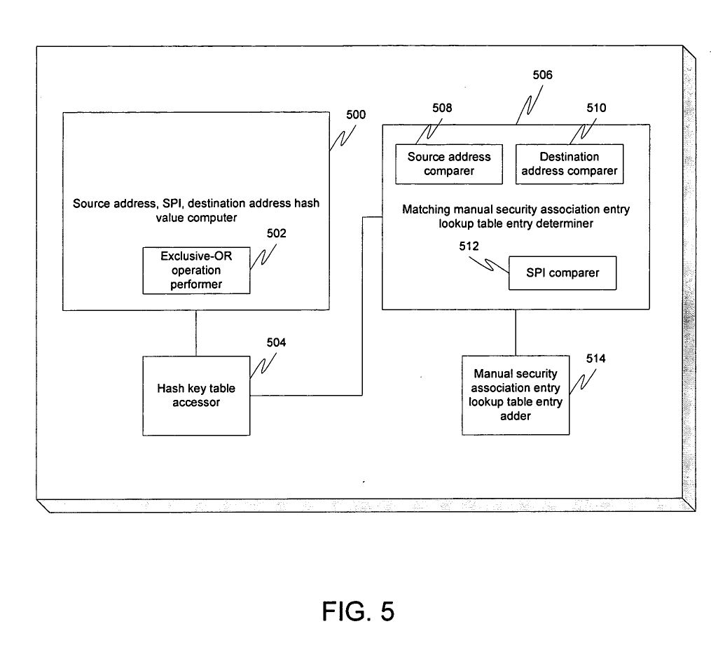

FIG. 5 is a block diagram illustrating an apparatus for manually configuring an SPI for a security association in accordance with an embodiment of the present invention. A source address, destination address, SPI hash key computer 500 may compute a hash key based on the destination address, source address, and SPI from the packet. Computing the hash key may include performing an exclusive-OR operation using an exclusive-OR operation performer 502 on the destination address, SPI, and source address indicated by the packet.

A hash key table accessor 504 coupled to the source address, destination address, SPI hash key computer 500 may access a hash key table using the hash key. This hash key table may include, for each entry, a pointer to a manual security association entry lookup table corresponding to that particular hash index. As there is the possibility that there will be more than one security association sharing the same hash key, each manual security association entry lookup table may contain multiple entries. It should also be noted that the separation of the manual security association entry lookup tables is merely an implementation choice. One of ordinary skill in the art would recognize it is possible to have all the manual security association entry lookup tables combined into one big table, with pointers or other devices used to distinguish between the end of one and the beginning of another. Nevertheless, for purposes of this document, the term manual security association entry lookup table should be interpreted to allow either implementation.

A matching manual security association entry lookup table entry determiner 506 coupled to the hash key table accessor 504 may access the manual security association entry lookup table referenced by the pointer and determine if an entry matches the packet. The manual security association entry lookup table entries may contain security association information such as source address, destination address, and SPI. The matching manual security association entry lookup table entry determiner 506 may contain a source address comparer 508, a destination address comparer 510, and an SPI comparer 512, which may compare these three parameters to the source address, destination address, and SPI indicated by the packet to determine if a match occurs. If there is no match, then the security association may be set up and an entry added to the table containing the security association information using a manual security association entry lookup table entry adder 514.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for determining a security association for a packet in a computer network, the packet containing a source address, a destination address, and a security parameter index (SPI), the method comprising:
computing a hash key based on the source address, destination address, and SPI in the packet;
accessing an entry in a hash key table corresponding to said hash key, the entry containing a pointer to a manual security association entry lookup table;
determining if any entries in said manual security association entry lookup table match the packet; and
utilizing security association information indicated by a matching entry in said manual security association entry lookup table if a matching entry exists in said manual security association entry lookup table.

2. The method of claim 1, wherein said computing includes:
performing an exclusive-OR operation on the source address, destination address, and SPI in the packet.

3. The method of claim 2, wherein said performing includes performing an exclusive-OR operation on an upper half of each of the source address, destination address, and SPI with the lower half of the source address, destination address, and SPI, respectively, before performing said exclusive-OR operation on the source address, destination address, and SPI.

4. The method of claim 1, wherein said determining includes, for each entry in the manual security association entry lookup table:
comparing a source address for the entry in the manual security association entry lookup table with the source address indicated by the packet;
comparing a destination address for the entry in the manual security association entry lookup table with the destination address indicated by the packet;
comparing an SPI for the entry in the manual security association entry lookup table with the SPI indicated by the packet; and
determining that a match has occurred if said source address, destination address, and SPI all match.

5. The method of claim 1, wherein said security association information includes a security association database address used for decryption.

6. A method for configuring a security association for a packet in a computer network, the packet containing a source address, a destination address, and a security parameter index (SPI), the method comprising:
computing a hash key based on the source address, destination address, and SPI in the packet;
accessing an entry in a hash key table corresponding to said hash key, the entry containing a pointer to a manual security association entry lookup table;
determining if any entries in said manual security association entry lookup table match the packet; and
adding an entry to the manual security association entry lookup table for the security association if no match is found in the manual security association entry lookup table, the entry containing security association information.

7. The method of claim 6, wherein said computing includes:
performing an exclusive-OR operation on the source address, destination address, and SPI in the packet.

8. The method of claim 7, wherein said performing includes performing an exclusive-OR operation on an upper half of each of the source address, destination address, and SPI with the lower half of the source address, destination address, and SPI, respectively, before performing said exclusive-OR operation on the source address, destination address, and SPI.

9. The method of claim 6, wherein said determining includes, for each entry in the manual security association entry lookup table:
comparing a source address for the entry in the manual security association entry lookup table with the source address indicated by the packet;
comparing a destination address for the entry in the manual security association entry lookup table with the destination address indicated by the packet;
comparing an SPI for the entry in the manual security association entry lookup table with the SPI indicated by the packet; and
determining that a match has occurred if said source address, destination address, and SPI all match.

10. The method of claim 6, wherein said security association information includes a security association database address used for decryption.

11. An apparatus for determining a security association for a packet in a computer network, the packet containing a source address, a destination address, and a security parameter index (SPI), the apparatus comprising:
a source address, destination address, SPI hash key computer;
a hash key table accessor coupled to said source address, destination address, SPI hash key computer;
a matching manual security association entry lookup table entry determiner coupled to said hash key table; and
a security association information utilizer coupled to said matching manual security association entry lookup table entry determiner.

12. The apparatus of claim 11, wherein said source address, destination address, SPI hash key computer includes an exclusive-OR operation performer.

13. The apparatus of claim 11, wherein said matching manual security association entry lookup table entry determiner includes:
a source address comparer;
a destination address comparer; and
an SPI comparer.

14. An apparatus for configuring a security association for a packet in a computer network, the packet containing a source address, a destination address, and a security parameter index (SPI), the apparatus comprising:
a source address, destination address, SPI hash key computer;
a hash key table accessor coupled to said source address, destination address, SPI hash key computer;
a matching manual security association entry lookup table entry determiner coupled to said hash key table; and
a manual security association entry lookup table entry adder coupled to said matching manual security association entry lookup table entry determiner.

15. The apparatus of claim 14, wherein said source address, destination address, SPI hash key computer includes an exclusive-OR operation performer.

16. The apparatus of claim 14, wherein said matching manual security association entry lookup table entry determiner includes:
a source address comparer;
a destination address comparer; and
an SPI comparer.

17. An apparatus for determining a security association for a packet in a computer network, the packet containing a source address, a destination address, and a security parameter index (SPI), the apparatus comprising:
means for computing a hash key based on the source address, destination address, and SPI in the packet;
means for accessing an entry in a hash key table corresponding to said hash key, the entry containing a pointer to a manual security association entry lookup table;
means for determining if any entries in said manual security association entry lookup table match the packet; and
means for utilizing security association information indicated by a matching entry in said manual security association entry lookup table if a matching entry exists in said manual security association entry lookup table.

18. The apparatus of claim 17, wherein said means for computing includes:
means for performing an exclusive-OR operation on the source address, destination address, and SPI in the packet.

19. The apparatus of claim 18, wherein said means for performing includes means for performing an exclusive-OR operation on an upper half of each of the source address, destination address, and SPI with the lower half of the source address, destination address, and SPI, respectively, before performing said exclusive-OR operation on the source address, destination address, and SPI.

20. The apparatus of claim 17, wherein said means for determining includes, for each entry in the manual security association entry lookup table:
means for comparing a source address for the entry in the manual security association entry lookup table with the source address indicated by the packet;
means for comparing a destination address for the entry in the manual security association entry lookup table with the destination address indicated by the packet;
means for comparing an SPI for the entry in the manual security association entry lookup table with the SPI indicated by the packet; and
means for determining that a match has occurred if said source address, destination address, and SPI all match.

21. The apparatus of claim 17, wherein said security association information includes a security association database address used for decryption.

22. An apparatus for configuring a security association for a packet in a computer network, the packet containing a source address, a destination address, and a security parameter index (SPI), the apparatus comprising:
means for computing a hash key based on the source address, destination address, and SPI in the packet;
means for accessing an entry in a hash key table corresponding to said hash key, the entry containing a pointer to a manual security association entry lookup table;
means for determining if any entries in said manual security association entry lookup table match the packet; and
means for adding an entry to the manual security association entry lookup table for the security association if no match is found in the manual security association entry lookup table, the entry containing security association information.

23. The apparatus of claim 22, wherein said means for computing includes:
means for performing an exclusive-OR operation on the source address, destination address, and SPI in the packet.

24. The apparatus of claim 23, wherein said means for performing includes means for performing an exclusive-OR operation on an upper half of each of the source address, destination address, and SPI with the lower half of the source address, destination address, and SPI, respectively, before performing said exclusive-OR operation on the source address, destination address, and SPI.

25. The apparatus of claim 22, wherein said means for determining includes, for each entry in the manual security association entry lookup table:
means for comparing a source address for the entry in the manual security association entry lookup table with the source address indicated by the packet;
means for comparing a destination address for the entry in the manual security association entry lookup table with the destination address indicated by the packet;
means for comparing an SPI for the entry in the manual security association entry lookup table with the SPI indicated by the packet; and
means for determining that a match has occurred if said source address, destination address, and SPI all match.

26. The apparatus of claim 22, wherein said security association information includes a security association database address used for decryption.

27. A program storage device readable by a machine, tangibly embodying a program of instructions executable by the machine to perform a method for determining a security association for a packet in a computer network, the packet containing a source address, a destination address, and a security parameter index (SPI), the method comprising:
computing a hash key based on the source address, destination address, and SPI in the packet;
accessing an entry in a hash key table corresponding to said hash key, the entry containing a pointer to a manual security association entry lookup table;
determining if any entries in said manual security association entry lookup table match the packet; and
utilizing security association information indicated by a matching entry in said manual security association entry lookup table if a matching entry exists in said manual security association entry lookup table.

28. A program storage device readable by a machine, tangibly embodying a program of instructions executable by the machine to perform a method for configuring a security association for a packet in a computer network, the packet containing a source address, a destination address, and a security parameter index (SPI), the method comprising:
computing a hash key based on the source address, destination address, and SPI in the packet;
accessing an entry in a hash key table corresponding to said hash key, the entry containing a pointer to a manual security association entry lookup table;
determining if any entries in said manual security association entry lookup table match the packet; and
adding an entry to the manual security association entry lookup table for the security association if no match is found in the manual security association entry lookup table, the entry containing security association information.
